(19) United States
(12) Patent Application Publication
(10) Pub. No.: US 2016/0103497 A1
(43) Pub. Date: Apr. 14, 2016

(54) INFORMATION PROCESSING APPARATUS

(71) Applicant: CANON KABUSHIKI KAISHA, Tokyo (JP)

(72) Inventors: Takuya Yamaguchi, Nagareyama-shi (JP); Haruhiko Nakatsu, Moriya-shi (JP)

(21) Appl. No.: 14/872,449

(22) Filed: Oct. 1, 2015

(30) Foreign Application Priority Data
Oct. 8, 2014 (JP) 2014-207545

(51) Int. Cl. G06F 3/01; G06K 9/00; G06F 3/03; G06F 3/042; G02B 7/182; G02B 27/64

(52) U.S. Cl. CPC G06F 3/017; G02B 7/182; G02B 27/646; G06F 3/0325; G06F 3/0425; G06K 9/00355

(57) ABSTRACT

An information processing apparatus is provided with a projection unit, a mirror unit that includes a mirror, and a detection unit. In an in-plane direction of the mirror, let a first direction be a projection line direction when an optical axis of the projection unit is projected onto the plane of the mirror, and in the in-plane direction of the mirror, let a second direction be a direction that is perpendicular to the first direction. The apparatus further includes a first supporting unit that supports the mirror; and a second supporting unit that supports the mirror. The first supporting unit and the second supporting unit are provided such that a primary natural frequency in the second direction is lower than a primary natural frequency in the first direction.

### BACKGROUND OF THE INVENTION

1. Field of the Invention

The present invention relates to an information processing apparatus that has a projection unit that projects data onto a platform and a detection unit that detects motions made by a user.

2. Description of the Related Art

A user interface system is used in which intuitive operations are performed by recognizing a gesture made by the user with respect to a video projected by a projector. In such a system, a user gesture made with respect to a projected moving image is recognized using a touch panel and video recognition technology.

Japanese Patent Laid-Open No. 2008-134793 discloses technology that precisely detects text input operations performed by the user with respect to a video projected onto a projection subject such as a table. The above is configured such that a base unit, to which the projection unit and an image capturing unit are fixed, is attached to a stand using a universal joint so that projection and image capturing of the projection subject are performed from above.

In such an information processing apparatus, in order to suppress an increase in size of the apparatus in the vertical direction while also ensuring the projection distance, a configuration is conceivable in which the projection unit is arranged below the information processing apparatus, and projection is performed by reflecting light from the projection unit one time with a mirror that is arranged above the information processing apparatus. In this case, it is conceivable to have a case in which a column for supporting the mirror is arranged towards the up-stream side in the projection direction so that the light projected onto the mirror and thus reflected is not interrupted. At this time, in the case in which vibration occurs on the installation surface of the apparatus, the mirror is likely to vibrate also due to the influence of being supported by one side, and therefore there is a risk that the vibration will lead to an increase in blurring of the projected image and incorrect detection by the detection unit.

### SUMMARY OF THE INVENTION

The present invention has been made in view of the above issues, and provides an information processing apparatus including a projection unit that projects an image, a mirror that reflects light from the projection unit, and a detection unit that detects motions made by the user, and in this information processing apparatus, obstruction of the projected light reflected by the mirror can be suppressed while also being able to mitigate the influence of vibrations.

According to a first aspect of the present invention, there is provided an information processing apparatus comprising: a projection unit configured to project an image; a mirror unit provided with a mirror that reflects the image projected by the projection unit towards a projection surface; a detection unit configured to detect motion of a detection target in a projection area of the projection unit via the mirror; in an in-plane direction of the mirror, letting a first direction be a projection line direction when an optical axis of the projection unit is projected onto the plane of the mirror, and in the in-plane direction of the mirror, letting a second direction be a direction that is perpendicular to the first direction, a first supporting unit configured to support the mirror and to be connected to the mirror on a side on which the projection unit is arranged relative to an intersection point between the optical axis of the projection and the mirror in the first direction; and a second supporting unit configured to support the mirror and to be connected to the mirror unit on the side on which the projection unit is arranged relative to the intersection point between the optical axis of the projection and the mirror in the first direction, and at a position that is different from the first supporting unit in the second direction, wherein the first supporting unit and the second supporting unit are provided such that in a state in which the first supporting unit and the second supporting unit are attached to an apparatus main body, letting a side of the first supporting unit and the second supporting unit attached to the apparatus main body be a fixed end, and letting the side of the first supporting unit and the second supporting unit attached to the mirror unit be a free end, a primary natural frequency in a case in which the free ends of the first supporting unit and the second supporting unit vibrate in the second direction is lower than a primary natural frequency in a case in which the free ends of the first supporting unit and the second supporting unit vibrate in the first direction.

Further features of the present invention will become apparent from the following description of exemplary embodiments with reference to the attached drawings.

### BRIEF DESCRIPTION OF THE DRAWINGS

FIGS. 1A and 1B are diagrams showing a configuration of an information processing apparatus according to an embodiment of the present invention.

FIG. 2 is a perspective view showing a configuration of the information processing apparatus according to an embodiment.

FIG. 3A is a side cross section of the information processing apparatus according to an embodiment.

FIG. 3B is a top view of the information processing apparatus according to an embodiment.

FIG. 4 is a schematic diagram showing the information processing apparatus according to an embodiment in a state of being used.

FIG. 5 is a diagram showing vibration modes of the information processing apparatus according to an embodiment.

FIGS. 6A to 6D are diagrams showing a cross-sectional shape of a side frame.

FIG. 7 is a side view showing an optical path of the information processing apparatus according to an embodiment.

FIG. 8 is a side view showing the optical path in a case in which the arrangement of a camera and a gesture sensor has been reversed.

FIG. 9 is a diagram showing a state of a projection area viewed facing a projection surface.

FIG. 10 is a diagram showing the state of an imaging area viewed facing an image capturing surface.

FIG. 11 is a diagram showing an example of a configuration from which the gesture sensor has been omitted.

### DESCRIPTION OF THE EMBODIMENTS

Embodiments of the present invention will be described in detail below with reference to the accompanying drawings. Constituent elements described in the following embodiments are merely examples, and the scope of the present invention is in no way limited to only these examples.

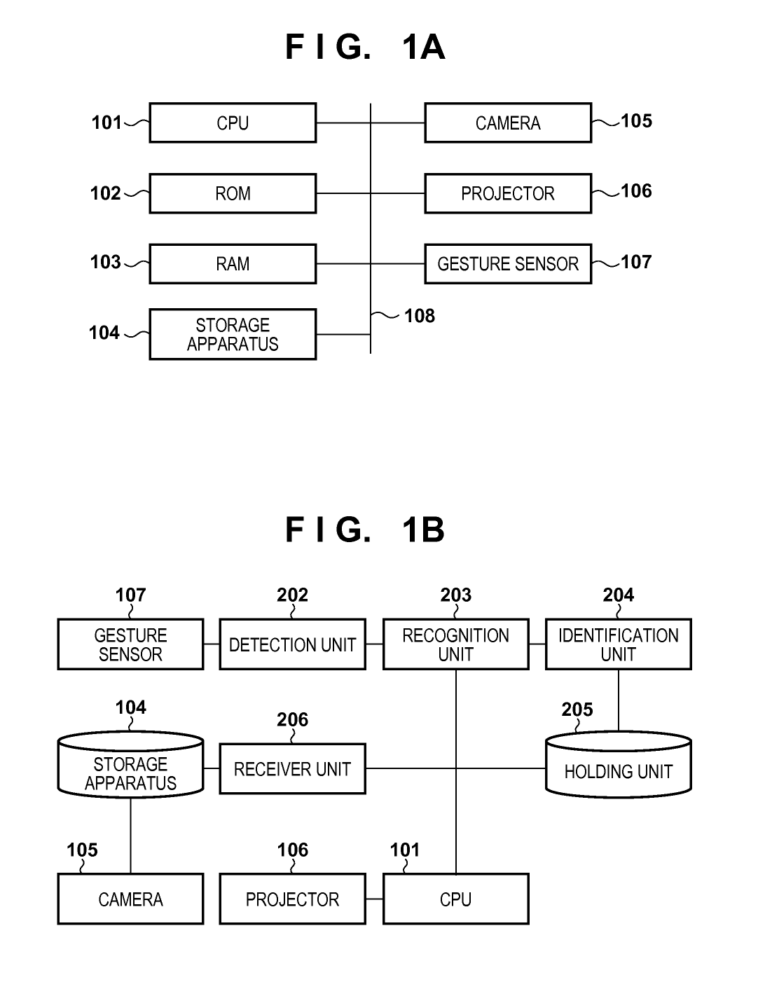

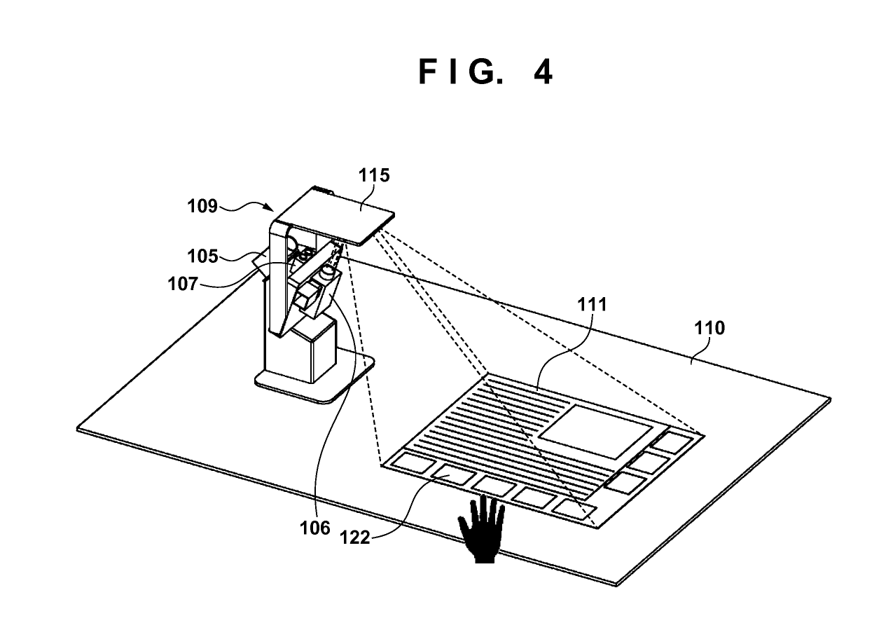

FIG. 1A is a diagram showing the hardware configuration of the information processing apparatus according to the present embodiment. In FIG. 1A, a CPU 101 made up of a microcomputer performs arithmetic operations, logical determination, and the like for various types of processing, and controls the constituent elements that are connected to a system bus 108. A ROM 102 is a program memory that stores programs for control to be performed by the CPU 101. A RAM 103 is a data memory that has a work area for the above-mentioned programs for the CPU 101, a save area for data during error processing, and a load area for the above-mentioned control programs, for example. A storage apparatus 104 is constituted by a hard disk, an externally connected memory apparatus, or the like, and the storage apparatus 104 stores various types of data such as electronic data and programs according to the present embodiment. A camera 105 captures an image of a work space in which the user performs an operation, and provides the captured image to a system as an input image. A projector 106 projects video including electronic data and user interface components onto the work space. A gesture sensor 107 is, for example, an infrared light sensor that detects a motion such as a hand motion made by the user in the work space, and based on this detection, detects whether or not the user has touched an operation button or the like that is projected onto a projection surface 110 (see FIG. 4).

FIG. 1B is a diagram showing a functional configuration of the information processing apparatus according to the present embodiment. In FIG. 1B, the camera 105 captures images of text and like hand-written by the user, and determines the characters, etc. of the text. Also, the projector 106 projects a user interface screen or the like onto the projection surface 110 (see FIG. 4). The gesture sensor 107 emits infrared light and detects an operation made by a hand or the like of the user with respect to the user interface, etc. projected by the projector 106 onto the projection surface 110 into the work space on the projection surface 110 (see FIG. 4). A detection unit 202 is constituted by the CPU, the ROM, and the RAM (hereinafter, the CPU 101 etc.), and detects an area in which a hand of the user exists and an area in which a finger of the hand of the user exists using a detection signal output by the gesture sensor 107. Below, “detecting a hand of the user” and “detecting a finger” are both used.

A recognition unit 203 is constituted by the CPU etc., and recognizes gesture operations performed by the user by tracking the finger of the user detected by the gesture sensor 107 and the detection unit 202. An identification unit 204 is constituted by the CPU etc., and identifies which finger of the user executed an operation that was recognized by the recognition unit 203. A holding unit 205 is constituted by the CPU etc., and stores information regarding the object that the user has designated from out of the objects included in the projected electronic data with a gesture operation, in association with the finger used for the gesture operation in the storage area provided in the RAM 103. A receiver unit 206 is constituted by the CPU etc., and receives an editing operation designated with respect to the electronic data made using the gesture operation recognized by the recognition unit 203, and updates the electronic data stored in the storage apparatus 104 as needed. The storage apparatus 104 stores the electronic data that is to undergo the editing operation. The CPU 101 references information held by the holding unit 205 in accordance with the gesture recognized by the recognition unit 203, and generates a projection image to be projected into the work space. The projector 106 projects the projection video generated by the CPU 101 into the work space that includes the projection surface 110 and the hand of the user in the vicinity of the projection surface.

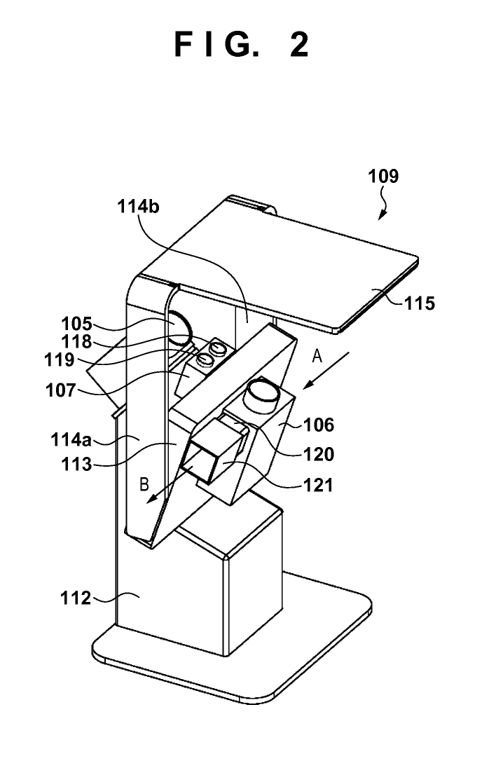

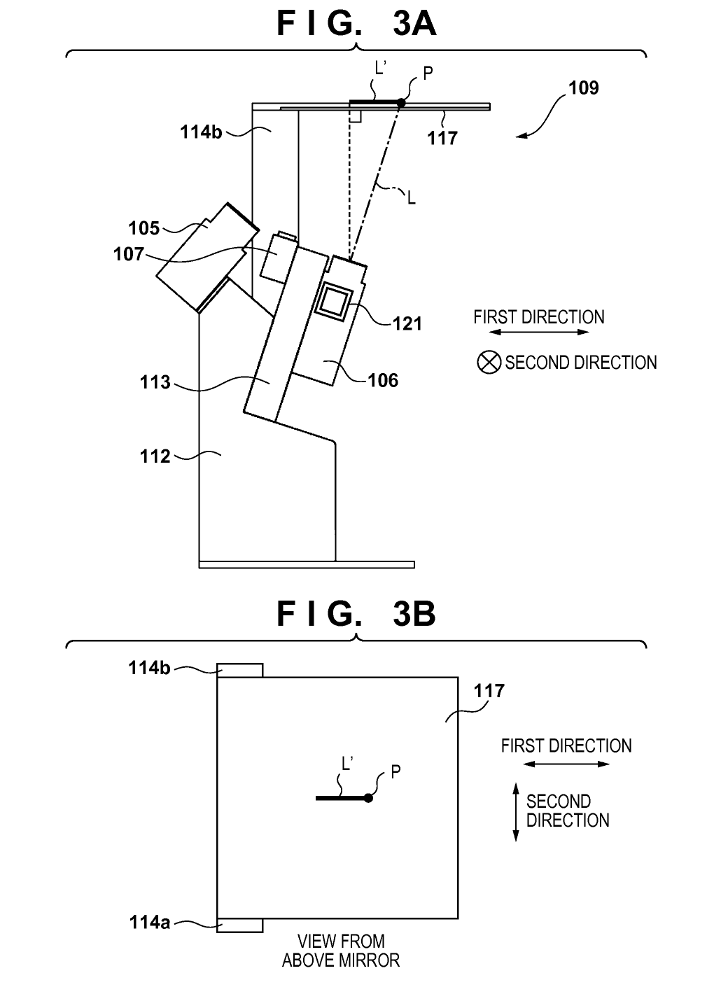

FIG. 2 is an external perspective view showing the configuration of an information processing apparatus 109 according to the present embodiment, and FIG. 3A is a side cross-sectional view of the information processing apparatus 109. FIG. 3B is a top view of the information processing apparatus 109. In FIG. 2 and FIGS. 3A and 3B, the camera 105 and a main frame 113 are fixed to a stand 112. The camera 105 is arranged such that its optical axis is obliquely upward relative to the horizontal plane. The main frame 113 supports the projector 106 and the gesture sensor 107 respectively on the top side and on the bottom side. A gesture sensor light emitting unit 118 and a gesture sensor light receiving unit 119 are arranged in the gesture sensor 107. The projector 106 and the gesture sensor 107 are each arranged so that their optical axes are obliquely upward relative to the horizontal plane.

The main frame 113 horizontally supports a mirror unit 115 in the upper portion of the mainframe 113 via side frames (support members) 114a and 114b. A mirror 117 is attached to the bottom surface of the mirror unit 115 and reflects the item projected from the projector 106 downward. The mirror 117 is a flat mirror. Also, a fan 120 and a duct 121 for cooling the projector 106 are provided on the main frame 113. The projector 106 intakes air from a direction A using the fan 120 and discharges it in a direction B. Furthermore, this configuration makes it possible to prevent heat from the projector 106, which is a heat generator, having an influence in terms of optical performance on the camera 105 and the gesture sensor 107, by shielding (insulating) the projector 106 from the camera 105 and the gesture sensor 107 using the main frame 113. As shown in FIGS. 3A and 3B, heat generated by the projector 106, which is a heat source, is blocked by the main frame 113, and is discharged in a direction toward the front of the paper via the duct 121 without moving in the direction of the camera 105 and the gesture sensor 107.

FIG. 4 is a diagram showing the information processing apparatus 109 according to the present embodiment in a state of being used. First, projection will be described. The projector 106 of the information processing apparatus 109 performs projection facing obliquely upward, and the light beam reflected by the mirror unit 115 forms an electronic data image 111 on the projection surface 110. The user performs operations on the electronic data image 111. A menu button 122 is included in the projected electronic data image 111, and the user uses their finger to turn power ON or OFF and select other operations. This selection operation is detected by the gesture sensor 107, and the electronic data image 111 functions as an interface.

Next, image capturing will be described. An object (a document or the like) to be imaged is arranged on the projection surface 110 when image capturing is to be performed. Then, a reflection image that appears on the mirror unit 115 is captured by the camera 105.

Next, detection using the gesture sensor 107 will be described. Infrared light is emitted from the gesture sensor light emitting unit 118, the light beam reflected by the mirror unit 115 is reflected by an object (a finger of the detection target or the like) on the projection surface 110 (in the projection area), is reflected again by the mirror unit 115, and is then detected by the gesture sensor light receiving unit 119.

As described above, the same mirror unit 115 used for projection, imaging, and gesture detection is used to reflect downward, and therefore the camera 105, the projector 106, and the gesture sensor 107 can be arranged below the information processing apparatus 109. For this reason, the overall height of the information processing apparatus 109 decreases, and the natural frequency of the main body of the apparatus increases, and therefore it is possible to mitigate influence on the camera 105, the projector 106, and the gesture sensor 107 by force from the outside in the installation environment and vibration generated by the main body of the apparatus.

On the other hand, the mirror 117 is arranged above the information processing apparatus 109, and therefore the natural frequency is low, and vibration is likely to be weak. However, depending on the vibration mode of the vibration of the mirror 117, there are large and small influences on the function of the information processing apparatus 109 (projection, imaging, and the position precision in gesture detection).

Next, the side frames 114a and 114b that function as support members supporting the mirror will be described. In the present embodiment, as shown in FIGS. 3A and 3B, the side frames 114a and 114b are arranged on the left side in FIGS. 3A and 3B relative to the mirror 117. As shown in FIG. 4, light projected by the projector 106 or the like expands as it is projected toward a projection surface, and thus the above was performed in order to prevent the projected light from being blocked as much as possible.

Specifically, as shown in FIGS. 3A and 3B, a first direction (the horizontal direction in FIG. 3A) is a direction indicated by a projection line L′ of an optical axis L of the projector 106 when projected perpendicularly onto the mirror 117. Also, a second direction (a direction perpendicular to the paper surface of FIG. 3A) is a direction that is perpendicular to the first direction in the in-plane direction of the mirror 117. Also, P is the intersection point between the optical axis L and the mirror. At this time, the side frames 114a and 114b, are arranged towards a side (left side in FIGS. 3A and 3B) on which the projector 106 is arranged relative to the point P in the first direction.

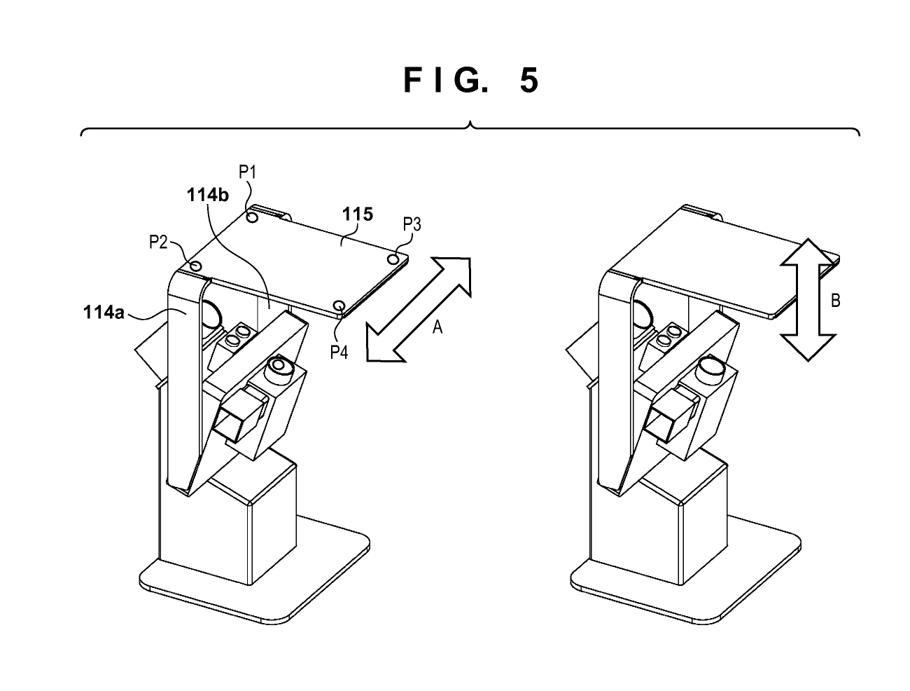

FIG. 5 is a schematic diagram showing vibration modes of the information processing apparatus 109 according to the present embodiment. Vibration in the plane of the mirror 117 (vibration in the direction A) does not influence the reflected light, and therefore there are no cases in which vibration in the plane of the mirror 117 influences the projection, imaging, and the position precision in gesture recognition. Here the direction A is the second direction that was defined above. On the other hand, rough vibration (vibration in the direction B) in the vertical direction of the mirror 117 causes the path of the reflected light to change, and therefore there is a risk that the vibration will lead to vibrating of the projection image, blurring of the captured image, incorrect detection in gesture detection, or the like.

Thus, in the present embodiment, considering the side frames 114a and 114b to be beams whose fixed ends are the portions attached to the main frame (the portions fixed to the sides of the apparatus main body), and whose free ends are the mirror unit supporting portions, the primary natural frequency of vibration of the side frames 114a and 114b in the direction A (the second direction) is lower than the primary natural frequency of vibration of the side frames 114a and 114b in the first direction. In doing so, vibration in the first direction is less likely to occur with respect to vibrations in the direction A (the second direction) of the side frames 114a and 114b.

In other words, if the natural frequency in the direction A (the second direction) is low and vibration is likely to occur, the energy of the vibration is absorbed by the vibration in the direction A (the second direction), thus making it difficult for vibration to occur in the first direction. As a result of this, in the first direction, an end portion of the mirror located on the side opposite to the side arm is not likely to generate vibration in the direction B. Specifically, the cross-sectional shape that is perpendicular to the vertical direction of the side frames 114a and 114b is a rectangular shape (52 mm×8 mm), and thus the natural frequency in the direction A is set lower than the natural frequency of the vibrations in the direction B. Note that, unless otherwise stated in particular, the natural frequency of the side frames 114a and 114b in the present embodiment refers to the natural frequency (primary natural frequency) of the side frames 114a and 114b in the case in which the side frames 114a and 114b undergo the above-described primary vibration.

In the present embodiment, design is performed so that the natural frequency of the side frames 114a and 114b in the direction A is 48 Hz, and the natural frequency in the direction B is 58 Hz. Specifically, the natural frequency in the direction A can be made smaller than the natural frequency in the direction B by forming the side frames such that the second moment of area in the direction perpendicular (the first direction) to the direction A in the in-plane direction of the mirror 117 is larger than the second moment of area of the arm in the direction A (the second direction). In this way, the natural frequency can be adjusted by adjusting the second moment of area of the arm.

Also, there is vibration of the mirror that is not dependent on the shape of the side frames. Consider the mirror to be a beam whose fixed end is the portion attached to the side frames in the state in which the mirror and the mirror unit are joined, and whose free end is the opposite side (reverse side). In this case, also in the case in which vibration of the mirror occurs due to primary vibration in which the free end of the mirror unit vibrates in the thickness direction of the mirror unit, rough vibration occurs similarly to the case in which vibration occurs in the first direction. For this reason, there is the risk that the above will lead to vibrating of the projection image, blurring of the captured image, and incorrect detection in gesture detection.

In view of this, in the present embodiment, the mirror with a comparatively thin thickness of 3 mm is used, and the mirror and the mirror unit are joined with double-sided tape at a total of five points on the mirror, i.e. the four corners and the center. The natural frequency of the mirror is increased by decreasing the weight of the mirror unit along with the mirror. In the present embodiment, design is performed so that, in the state in which the mirror and the mirror unit are joined, the primary natural frequency of the vibrations in the thickness direction of the free end of the above mirror unit is 100 Hz. As a result of this, vibration in the mirror is less likely to occur than vibration of the side frames in the direction A. Also, because the mirror and the mirror unit are formed with different materials, the mirror and the mirror unit are joined with double-sided tape to absorb the difference in thermal expansion. However, in the case of usage in an environment with a stable temperature, higher rigidity can be achieved and the natural frequency can be increased if an anaerobic adhesive or the like is used to join the mirror and the mirror unit.

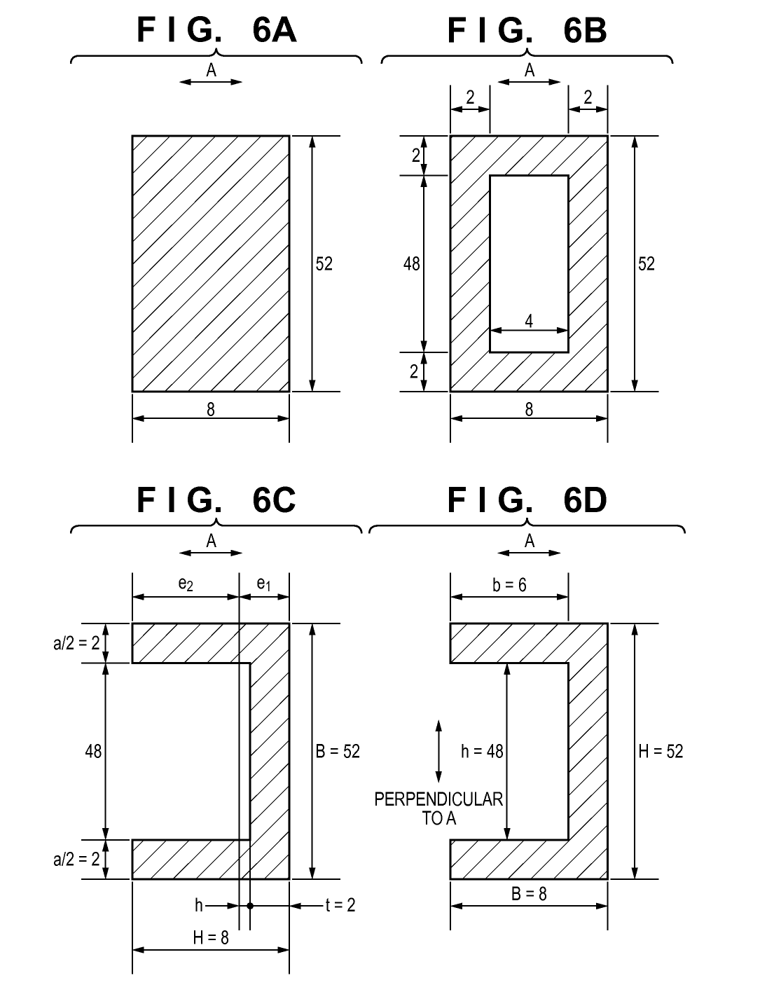

FIGS. 6A to 6D show the cross-sectional shape that is perpendicular to the vertical direction of the side frames 114a and 114b. A second moment of area I is expressed with the following formula (b: width, h: height).

I=bh³/12

The direction A has a width of 52 mm and a height of 8 mm when a second moment of area is being calculated for the direction A. Accordingly, the formula is:

I=52×8³/12=2218

and, the second moment of area I=0.22 (cm⁴).

Also, a width of 8 mm and a height of 52 mm applies for the second moment of area that is perpendicular to the direction A, and therefore the formula:

I=8×52³/12=93739

and, the second moment of area I=9.4 (cm⁴).

Note that here, if one arm is formed at an arbitrary position in the direction A, the vibration of the mirror is not parallel, but instead has a rotational component, and the path of the reflected light is changed. Accordingly, there is a need to provide at least two or more arms at arbitrary positions in the direction A. Specifically, the side frames 114a and 114b are provided at different positions in the direction A (the second direction). Furthermore, in the present embodiment, the arms are formed with a rectangular shape, but the arms are not limited to having a rectangular shape as long as the relation between the second moments of area is the same.

A specific method of measuring the natural frequency will be described below. Acceleration sensors P1 to P4 are attached to the four corners of the mirror unit 115 shown in FIG. 5. The acceleration sensors P1 to P4 are sensors that can detect acceleration in the first direction, the second direction (the direction A), and the direction B in FIGS. 3A and 3B. The acceleration sensors are directly attached to the reflecting surface of the mirror in the case in which the top surface of the mirror unit is a cover member or the like and does not vibrate in synchronization with the mirror. The installation surface of the information processing apparatus is fixed to the excitation apparatus, and vibration is applied from an arbitrary direction. At this time, the vibration frequency from the excitation apparatus is gradually changed.

An example of the configuration of the present embodiment will be described below. In the case of the present embodiment, if the vibration frequency approaches 48 Hz, the side frames holding the mirror unit resonate in the direction A (the second direction). As a result, acceleration in the first direction at P1 to P4 relative to acceleration in the direction A in the vicinity of the installation surface of the information processing apparatus (or acceleration input by the excitation apparatus) exhibits a local maximum with respect to a change in frequency. On the other hand, the side frames holding the mirror unit do not resonate in the first direction that is perpendicular to the direction A. As a result, acceleration in the first direction at P1 to P4 is the same as acceleration in the first direction in the vicinity of the installation surface of the information processing apparatus (or the acceleration input by the excitation apparatus). Furthermore, if the vibration frequency approaches 58 Hz, the side frames that hold the mirror unit resonate in the first direction. As a result, acceleration in the first direction at P1 to P4 relative to acceleration in the first direction in the vicinity of the installation surface of the information processing apparatus (or acceleration input by the excitation apparatus) exhibits a local maximum with respect to changes in frequency. Also, the side frames are disposed on respective sides of the mirror unit, and therefore rotational vibration occurs centered around the vicinity of the portions attached to the main frame. As a result, acceleration in the direction B at P3 and P4 is larger than acceleration in the direction B at P1 and P2. Apart from the two vibration types described above, there is vibration of the mirror that generates blurring of the projection image. As described above, vibration is primary vibration in the case of considering the mirror unit to be a beam whose fixed end is the portion attached to the side frames and whose free end is the opposite side in the first direction. At this time, acceleration in the direction B at P3 and P4 is larger than acceleration in the direction B at P1 and P2. Note that the side frames are not in a state of resonating, and therefore acceleration in the first direction at P1 to P4 is the same as acceleration in the first direction in the vicinity of the installation surface of the information processing apparatus (or the acceleration input by the excitation apparatus). This vibration mode is a mode of vibration different from the vibration discussed in this specification.

FIGS. 6B to 6D show cross-sections in cases in which the arm has different shapes. FIG. 6B is a cross-sectional view in the case in which a hollow rectangular pipe is formed. In the case of obtaining a second moment of area in the direction A assuming the hollow rectangular pipe has an external shape of 8 mm×52 mm and has a thickness of 2 mm, the dimensions are width b=52, height h=8, gap width b1=48, and gap height h=4.

The second moment of area I is expressed with the following formula (b: width, h: height).

I=(bh³−b1h1³)/12

Accordingly the formula becomes,

I=(52×8³−48×4³)/12=1962

and, the second moment of area 1=0.20 (cm⁴).

Similarly, the direction perpendicular to the direction A is:

I=(8×52³−4×48³)/12=56875

and, the second moment of area I=5.7 (cm⁴).

FIGS. 6C and 6D are cross-sectional diagrams of a U-shaped arm. Letting the external shape be 8 mm×52 mm, and the thickness be 2 mm, in a case in which the second moment of area in the direction A is obtained, the dimensions shown in FIG. 6C apply.

First,

e1=(aH²+bt²)/(2(aH+bt))

and therefore,

e1=(4×82+48×22)/(2×(4×8+48×2))=1.75

### Next,

e2=H−e1=8−1.75=6.25

h=e1−t=1.75−2=−0.25

applies.

The second moment of area is expressed with the following formula:

I=(Be1³−bh+ae2)/3

and therefore,

I=(52×1.75³−48×(−0.25)+4×6.25³)/3=419

applies, and the second moment of area I=0.04 (cm⁴).

The dimensions shown in FIG. 6D apply in the case of obtaining the second moment of area in the direction perpendicular to the direction A.

Here,

I=(BH³−bh³)/12

applies, and therefore,

I=(8×52³−6×48³)/12=38442

applies, and the second moment of area is 3.8 (cm⁴).

Next, a method for determining the size of the mirror 117 will be described. The mirror 117 is arranged in the upper portion and is easily influenced by vibration, and therefore it is desirable to reduce the size and the weight of the mirror 117 as much as possible to increase the natural frequency. In order to reduce the size of the mirror 117, the camera 105, the projector 106, and the gesture sensor 107 are required to be optimally arranged.

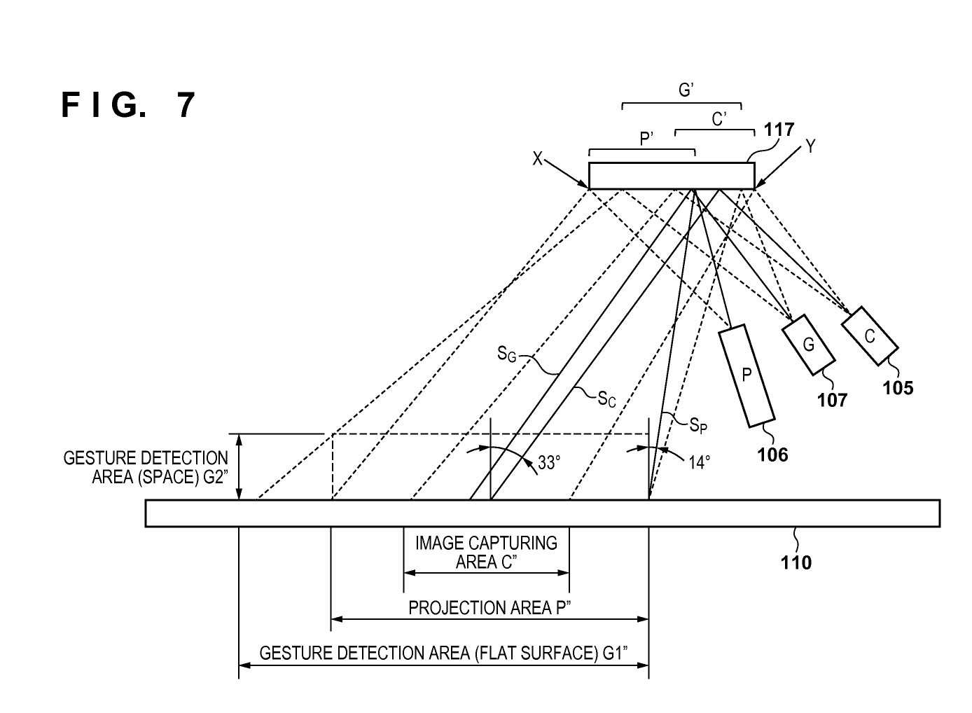

FIG. 7 is a cross-sectional diagram showing the optical path of the information processing apparatus 109 according to the present embodiment. Note that in the present embodiment, the projector 106 only uses one side of light with respect to the optical axis for projection.

Two lines extending from the projector 106 indicate projection luminous flux from the projector. The projection luminous flux emitted by the projector 106 gradually expands and is reflected by the mirror 117. The projection luminous flux that has been reflected forms a projection image in the projection area of the projection surface 110. In other words, the area is an area in which a shadow is formed on the projection image if a light blocking object is inserted into a portion of this luminous flux.

Two lines extending from the camera 105 indicate imaging luminous flux of the camera 105. An original is placed in the image capturing area on the projection surface 110 and faces a group of lenses of the camera 105, which are not shown, light is gradually converged via the mirror 117, light passes though the group of lenses, and an image is formed on an image capturing element of the camera 105. In other words, the area is an area in which imaging is performed with an object entering the image capturing area, if an object is inserted into a portion of this luminous flux.

There is a projection area P″, an image capturing area C″, and a gesture detection area (flat surface) G1″ on the projection surface 110. The size relationship between the areas on the projection surface 110 is as described below in light of usage applications by the user.

image capturing area C″<projection area P″<gesture detection area(flat surface)G1″

Because gesture detection is also performed in a space that has a height reaching 100 mm on the projection surface 110, a gesture detection area (space) G2″ is also needed. For this reason, the gesture detection area G1″ is required to be the largest. The projector 106 is arranged the nearest with respect to the projection area P″. This is to bring the angle of incidence of a beam of light projected by the projector 106 onto the projection surface 110 to a state near as possible to being perpendicular with respect to the projection surface in order to increase the resolution of the projection image as much as possible. Generally, the resolution of the projector 106 tends to be lower than the resolution of the camera 105 and the gesture sensor 107 in terms of device performance. For this reason, this arrangement has been performed to maintain the resolution of the projector 106, which is the most likely to undergo a decrease in resolution. Then, the camera 105 is arranged on the outside of the projector 106.

The gesture sensor 107 is arranged inside of a triangle formed by an optical path that is on the camera side (imaging unit side) of the luminous flux of the projector 106 and is between the projector 106 and the mirror 117 (the dashed line on that extends from the left of the projector 106 in FIG. 7), an optical path that is on the projector side (projection unit side) of the luminous flux of the camera 105 and is between the camera 105 and the mirror 117 (a dashed line extending from the left of the camera 105 in FIG. 7), and the projection surface 110.

The size of the mirror 117 in this case will be described. The size of the mirror 117 is required to be a size that fills the projection area P″, the image capturing area C″, the gesture detection area (plane) G1″, and the gesture detection area (space) G2″. The areas required on the mirror 117 are an image capturing area C′, a projection use area P′, and a gesture detection use area G′. At this time, in the horizontal direction, the projection area P″ and the nearest point X in the mirror 117 are determined by the projection use area P′ that is the optical path of the projector 106. Also, in the horizontal direction, the projection area P″ and the furthest point Y in the mirror 117 are determined by the image capturing use area C′ that is the optical path of the camera 105. Then, a gesture detection use area G′ becomes the widest area, and is thus arranged between the projection use area P′ and the image capturing use area C′. Accordingly, usage areas of the mirror 117 at least partially overlap and thus the size of the mirror 117 can be reduced in size as much as possible.

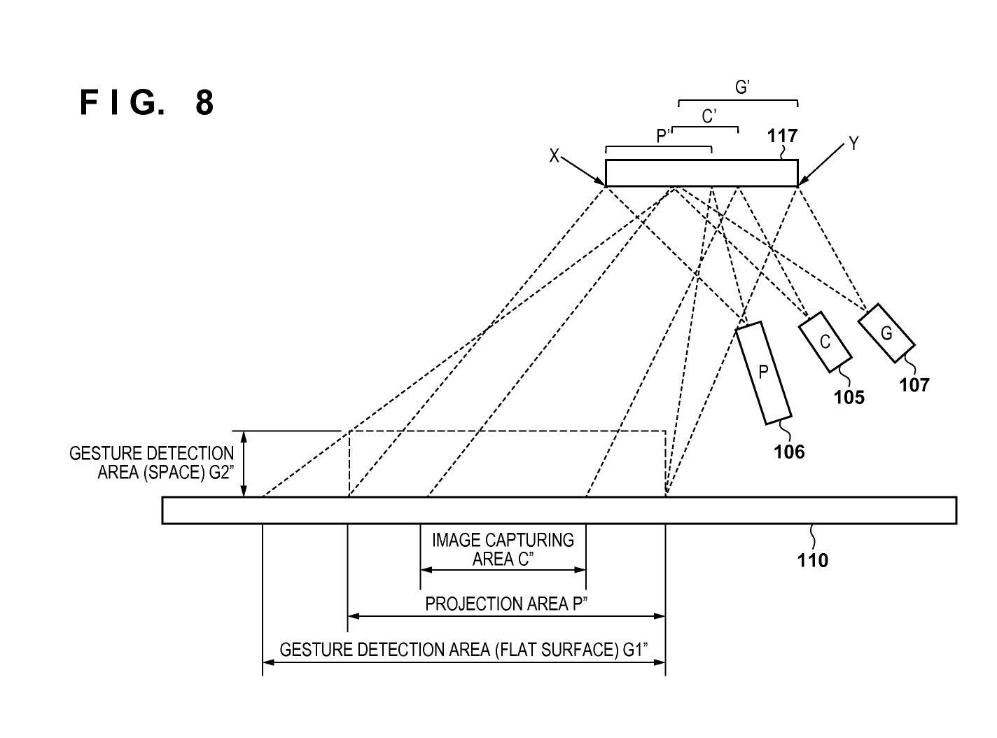

On the other hand, the case in which the camera 105 is arranged outward of the projector 106 and the gesture sensor 107 is arranged outward of the camera 105 will be described with reference to FIG. 8. FIG. 8 is a cross-sectional diagram showing the optical path in the case in which the arrangement of the camera 105 and the gesture sensor 107 is reversed. At this time, in the horizontal direction, the projection area P″ and the nearest point X in the mirror 117 are determined by the projection use area P′ that is the optical path of the projector 106 similar to that shown in FIG. 7. On the other hand, in the horizontal direction, the projection area P″ and the furthest point Y in the mirror 117 are determined by the gesture detection use area G′ that is the optical path of the gesture sensor 107. The gesture detection area G1″ that is needed for the gesture sensor 107 is larger than the image capturing area C″ that is needed for the camera 105, and therefore the point Y is positioned outward of the point Y in FIG. 7. As a result, the size of the mirror 117 increases.

Based on the above, arrangement of the camera 105, the projector 106, and the gesture sensor 107 in order to reduce the size of the mirror 117 is the order shown in FIG. 7 in which the projector 106 is nearest to the projection area P″, and then sequentially the gesture sensor 107 and the camera 105.

Note that, as shown in FIG. 7, the projector 106 performs projection, like a general projector, such that an image is only projected onto one side with respect to the optical axis of the lens. Let the beam of light projected through an optical axis of a lens be SP. The projector 106 is provided with an LCD panel as a light modulation element, and the resolution (dots) of projection image is determined by the light modulation element. The present embodiment is provided with a light modulation element that can display 1280 dots in a direction perpendicular to the paper sheet of FIG. 7, and display 800 dots in a direction parallel to the paper sheet of FIG. 7. The light modulation element is not limited to an LCD panel and may be a digital micro-mirror device (DMD) or the like. The projector 106 is disposed such that it is nearest to the projection area, along with being disposed so that the angle of the optical axis of the projector 106 relative to the axis perpendicular to the projection surface 110 is as small as possible.

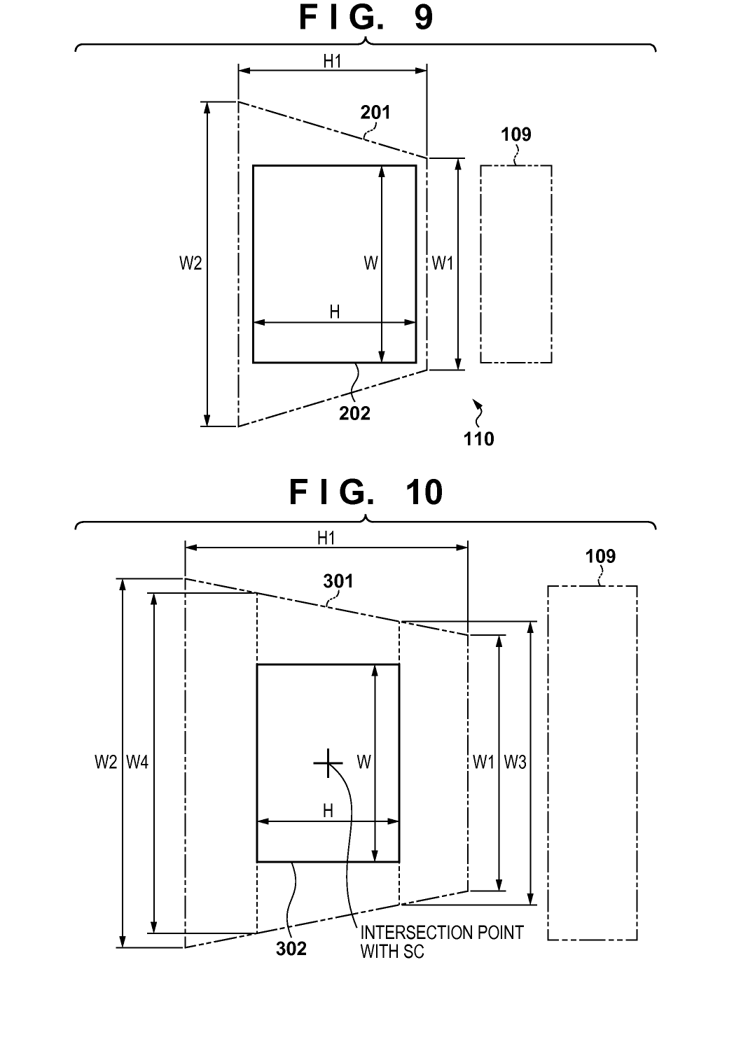

FIG. 9 shows the projection area when viewed facing the projection surface 110. The optical axis of the projector 106 is inclined, and therefore an image 201 projected onto the projection surface takes the shape of a trapezoid. A rectangular shaped image 202 of the projection surface is obtained by processing data of the image to be projected (so-called Keystone correction). In the present embodiment, the necessary image size is W=620 mm and H=460 mm. Accordingly, the image 201 prior to Keystone correction requires a size larger than or equal to 620 mm×460 mm. As shown in FIG. 7, assuming that the optical axis SP of the projector 106 is 14° relative to an axis that is perpendicular to the projection surface, and that the distance between the projector 106 and the projection surface 110 in the optical axis portion is 700 mm, the dimensions are therefore W1=620 mm, W2=716 mm, and H1=460 mm.

As described previously, the direction W is formed with 1280 dots, and therefore the resolution (dpi) in the direction W on the side near the information processing apparatus 109 is 52 dpi (=1280×25.4/620). Also, the resolution (dpi) on the side far from the information processing apparatus 109 in the direction W is 45 dpi (=1280×25.4/716). The resolution (dpi) gradually changes in a direction H, and therefore the side near the information processing apparatus 109 is 52 dpi, and the far side is 45 dpi, which is the same as the direction W.

The camera 105 captures an image so that the image is symmetrical with respect to an optical axis, like a general camera. Letting the beam of light projected through an optical axis of a lens be SC. The camera 105 is mounted with a 1/1.7 model CMOS sensor as an image capturing element, and the resolution (dots) is determined by the image capturing element. The present embodiment is provided with an image capturing element that can capture 4072 dots in the direction perpendicular to the paper sheet of FIG. 7, and 3046 dots in the direction that is parallel to the paper sheet of FIG. 7. The image capturing element is not limited to a CMOS sensor, but may also be a CCD or the like. The camera 105 is arranged so as not to physically interfere with the projector 106, as well as being arranged such that it can capture an image of a region whose center is approximately the same as the projection area.

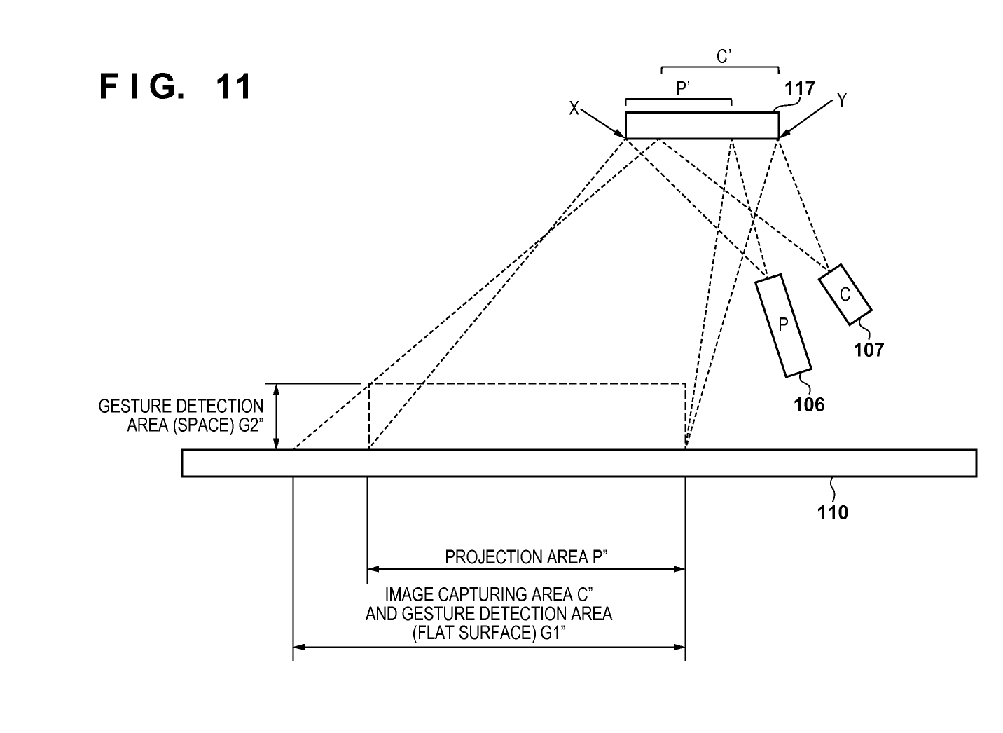

FIG. 10 shows the projection area when viewed facing the projection surface 110. The optical axis of the camera 105 is inclined, and therefore an image 301 projected onto the projection surface takes the shape of a trapezoid. In the present embodiment, the required image size for the image 302 is to be larger than or equal to W=432 mm and larger than or equal to H=297 mm so as to allow for imaging of an A3 original. Accordingly, the projection area 301 is required to be a size larger than or equal to 432 mm×297 mm.

As shown in FIG. 7, assuming that the optical axis of the camera 105 is 33° relative to the axis perpendicular to the projection surface and that the distance between the imaging unit and the projection surface in the optical axis portion is 900 mm, the dimensions are therefore W1=426 mm, W2=555 mm, W3=439 mm, and W4=525 mm. As described above, the direction W is formed with 4072 dots, and therefore the resolution (dpi) in the direction W on the side near the information processing apparatus 109 is 236 dpi (=4072×25.4/439). Also, the resolution (dpi) in the direction W on the side far from the information processing apparatus 109 is 197 dpi (=3046×25.4/525). The resolution (dpi) in the direction H as well gradually changes in the direction H, and therefore the side near the information processing apparatus 109 is 236 dpi and the far side is 197 dpi, which is similar to the direction W. A difference in image visibility due to deterioration of the resolution can be mitigated in the direction of the sheet paper by arranging the projector 106, which has low resolution, nearest to the projection area.

Note that in the description above, a case was described in which all three of the camera 105, the projector 106, and the gesture sensor 107 are used. However, as shown in FIG. 11, by imaging the motion of the hand of the user with the camera 105, the motion of the hand of the user is detected, and it is possible to omit the gesture sensor 107. In doing so, the cost of the information processing apparatus can be further reduced.

As described above, by arranging the projector so as to be as near as possible to the projection surface as in the above embodiment, it is possible to bring the angle of the optical axis projected relative to the projection surface near to being perpendicular, and it is possible to increase the resolving power of the projected image. Also, the size of the mirror can be reduced by arranging the camera, the projector, and the gesture sensor so that the camera is nearest to the projection area, and then sequentially the projector, and the gesture sensor, and vibrations that are harmful to the mirror can be suppressed.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-207545, filed Oct. 8, 2014, which is hereby incorporated by reference herein in its entirety.

What is claimed is:

1. An information processing apparatus comprising:
a projection unit configured to project an image;
a mirror unit provided with a mirror that reflects the image projected by the projection unit towards a projection surface;
a detection unit configured to detect motion of a detection target in a projection area of the projection unit via the mirror;
in an in-plane direction of the mirror, letting a first direction be a projection line direction when an optical axis of the projection unit is projected onto the plane of the mirror, and in the in-plane direction of the mirror, letting a second direction be a direction that is perpendicular to the first direction,
a first supporting unit configured to support the mirror and to be connected to the mirror on a side on which the projection unit is arranged relative to an intersection point between the optical axis of the projection and the mirror in the first direction; and
a second supporting unit configured to support the mirror and to be connected to the mirror unit on the side on which the projection unit is arranged relative to the intersection point between the optical axis of the projection and the mirror in the first direction, and at a position that is different from the first supporting unit in the second direction,
wherein the first supporting unit and the second supporting unit are provided such that in a state in which the first supporting unit and the second supporting unit are attached to an apparatus main body, letting a side of the first supporting unit and the second supporting unit attached to the apparatus main body be a fixed end, and letting the side of the first supporting unit and the second supporting unit attached to the mirror unit be a free end, a primary natural frequency in a case in which the free ends of the first supporting unit and the second supporting unit vibrate in the second direction is lower than a primary natural frequency in a case in which the free ends of the first supporting unit and the second supporting unit vibrate in the first direction.

2. The information processing apparatus according to claim 1, wherein the first supporting unit and the second supporting unit have a second moment of area in the second direction that is smaller than a second moment of area in the first direction.

3. The information processing apparatus according to claim 1, wherein letting a side of the mirror unit to which the first supporting unit and the second supporting unit are attached be a fixed end, and a side opposite to the fixed end be a free end, a primary natural frequency when the free end of the mirror unit vibrates in a thickness direction of the mirror unit is higher than a primary natural frequency when the first supporting unit and the second supporting unit vibrate with respect to the second direction.

4. The information processing apparatus according to claim 1, wherein a cross-sectional shape of the first supporting unit and the second supporting unit that is perpendicular to a vertical direction has a rectangular cross-sectional shape.

5. The information processing apparatus according to claim 4, wherein the rectangular shape is a hollow shape.

6. The information processing apparatus according to claim 1, further comprising an imaging unit configured to capture an image of a projection area of the projection unit,
wherein the projection unit has a resolution that is lower than that of the imaging unit.

7. The information processing apparatus according to claim 1,
wherein the mirror is arranged in an upper portion of the information processing apparatus, and
the projection unit and the detection unit are arranged at a position that is below the mirror relative to the information processing apparatus.

8. The information processing apparatus according to claim 7,
wherein an optical axis of the projection unit and an optical axis of the detection unit are directed toward the mirror, and
light that travels along the optical axis of the projection unit and the optical axis of the detection unit are reflected by the mirror so as to be directed downward.

9. The information processing apparatus according to claim 8, wherein the projection surface is arranged below the information processing apparatus.

10. The information processing apparatus according to claim 1, wherein the detection unit is arranged in a state of being thermally insulated from the projection unit.

11. The information processing apparatus according to claim 1, wherein the detection unit emits infrared light and detects a position of a hand of a user by receiving light that was reflected by the hand of the user.
